(19) United States
(12) Patent Application Publication
(10) Pub. No.: US 2006/0050792 A1
(43) Pub. Date: Mar. 9, 2006

(54) Method and device for processing digital images

(76) Inventors: Franck Abelard, Saint Armel (FR); Marc Amstoutz, Rennes (FR); Frederic Salaun, Saint Aubin Du Cormier (FR)

Correspondence Address: THOMSON LICENSING INC., PATENT OPERATIONS, PO BOX 5312, PRINCETON, NJ, 08543-5312, US

(21) Appl. No.: 10/522,256

(22) PCT Filed: Jul. 9, 2003
(86) PCT No.: PCT/EP03/07476

§ 371 Date: Aug. 9, 2005

(30) Foreign Application Priority Data
Jul. 26, 2002 (FR) 0209788

(51) Int. Cl. H04N 11/02; H04N 11/04; H04N 7/12; H04B 1/66

(52) U.S. Cl. 375/240.25

(57) ABSTRACT

The invention relates to a method of and a device for processing digital images. The device is such that, the images being transmitted from a server to a decoder using various modes of display, the images being coded in a dependent manner such that the coding of a first image is used to code a second image. The method is such that the order of transmission of the images from the server to the decoder is determined as a function of the dependence of these images and the mode of display requested by the decoder.

The present invention concerns a method and a device for processing digital images.

It is known to display a sequence of images coded by means of digital data according to various modes, a mode of display being defined by a direction and a speed of display dependent on the number of images displayed. For example, a sequence comprising five successive images M₁, M₂, M₃, M₄ et M₅ may be displayed according to a mode corresponding to a direction and a speed which are such that the images M₁, M₂, M₃, M₄ et M₅ are displayed successively.

According to another mode, the direction of display is reversed with respect to the first mode while the speed of display of the sequence is accelerated in such a way that only the images M₅, M₃ et M₁ are displayed successively.

According to a last example, the speed of display of the sequence is zero so that an image, for example M₁, is displayed continuously.

Additionally, it is known to code digital images of a sequence of images using the coding of a first image of the sequence to perform the coding of a second image of this sequence. Subsequently in the document, such images are said to be dependent.

Coded images of a sequence may be dependent, for example, when this sequence is coded according to the Motion Pictures Expert Group (MPEG) standard.

It is recalled that, in accordance with this MPEG standard, the coding of an image associates the coded image with one of the following three categories:
A category of so-called intra (I) images, an intra image being decodable and displayable without requiring the decoding of another image.
A category of so-called predictive (P) images, a predictive image requiring the decoding of the intra or predictive image transmitted prior to this predictive image so as to be displayed, and
A category of so-called bi-predictive (B) images, a bi-predictive image requiring the decoding of the images displayed prior and posterior to this bi-predictive image so as to be displayed.

The present invention results from the finding that the displaying of images according to a specified mode, that is to say according to a specified direction and specified speed, requires considerable manipulations of images and hence considerable resources in the decoding devices.

For example, considering the coding of images according to the MPEG standard, the displaying of a bi-predictive image requires the decoding of an image displayed previously and of an image displayed subsequently to this bi-predictive image, these three decoded images being displayed when the mode of display of the terminal corresponds to a speed such that the entire set of coded images are displayed.

Conversely, if the speed of display is such that the bi-predictive image is displayed while its prior and posterior images are not displayed, for example for accelerated display, these latter must nevertheless be transmitted and decoded so as to allow the displaying of the bi-predictive image.

It is apparent that as a function of the mode of display, first, non-displayed, images must be transmitted and decoded so as to allow the decoding of second images.

Similarly, when the mode of display is such that the entire set of coded images is displayed, a predictive image is decoded by means of an image previously transmitted and previously decoded so as to be displayed.

Conversely, if the speed of display is accelerated so that an image prior to a predictive image should not be displayed, this prior image is nevertheless transmitted and decoded so as to allow the decoding of the predictive image.

According to a last example, when the direction of display corresponds to the order of transmission of these images, a predictive image is decoded with the aid of an image previously decoded so as to be displayed.

However, if the direction of display is reversed, the decoding of a predictive image requires the decoding of the image transmitted prior to this predictive image even though this prior image may possibly be displayed only after the displaying of the predictive image.

Stated otherwise, the order in which the coded images are processed is unsuited to a reversed mode of display, thereby making it complex to process these images and increasing the display lags. The processing actually requires an analysis of the structure of the stream, a rearrangement of the images, multiple decodings entailing numerous resources in respect of the memory capacity required and of the power of the processors employed.

These drawbacks are made more acute when the coded images are transmitted by a server to one or more remote display terminals. Specifically, in addition to the drawbacks relating to the complexity of the decoding and to the lags required for this decoding, transmission resources are used to transmit first coded images, necessary for performing the decoding of second coded images, which are not displayed.

The present invention remedies at least one of these drawbacks. It relates to a method of processing digital images, these images being transmitted from a server to a decoder using various modes of display, images being coded in a dependent manner such that the coding of a first image is used to code a second image.

According to the invention, the order of transmission of the images from the server to the decoder is determined as a function of the dependence of these images and the mode of display requested by the decoder.

By virtue of such a method, the transmission of digital images can potentially be adapted to the mode of display in such a way as possibly to allow streamlining of the processing to be performed in the decoding device.

In the case where the coded images are transmitted by a server to a terminal, the invention may permit a limitation of the use of the transmission network by transmitting only a limited number of images.

According to a preferred embodiment, the mode of display used by the decoder is transmitted to the server so that the server performs the transmission of the images as a function of the mode of display used by the decoder.

This may permit a reduction in the number of images transmitted between the server and the decoder or decoders for which these images are intended. The decoders may thus indicate to the server the mode in which they are operating and thus the server adapts the transmission of the images as a function of this mode.

According to a preferred embodiment, when the server transmits coded images to the decoder, the server in parallel therewith transmits a command associated with each image comprising information allowing the decoder to process each image.

The images are transmitted from the server to the decoder in an order which no longer necessarily corresponds to the order of coding. In the case of images coded according to the MPEG-2 standard, the stream transmitted from the server to the decoder no longer complies with coding according to the MPEG-2 standard since the images are transmitted in a different order from the coding. Thus, the command transmitted with the data allows the decoder to decode the images of the stream even if this stream no longer complies with the norm in which the data were coded.

According to a preferred embodiment, the information comprises
a field indicating whether the said image is to be displayed,
a field indicating whether the said image is to be decoded,
a field indicating in which memory buffer of the decoder the said image is to be recorded after decoding,
a field indicating the index numbers of the memory buffers containing images serving for the decoding of the said image,
a field indicating the direction of display of the images.

This information tells the decoder the way in which it should process the image that it receives and where it should record this image.

According to a preferred embodiment, when the terminal receives coded images and a command associated with each image, the command is transmitted to a first memory buffer while the coded images are transmitted to other memory buffers.

According to a preferred embodiment, the commands stored in the first memory buffer are processed as a function of their order of storage in the said memory buffer.

According to a preferred embodiment, use is made of modes of display defined by a direction of display, that is to say the order in which images are displayed, as well as by a speed of display such that a variable number of images is displayed for one and the same processed group of images.

The digital decoders in charge of the decoding of video sequences are often obliged to process special modes such as fast forward, delayed playback, rewind.

According to a preferred embodiment, when the decoder changes display mode, the size of the first memory buffer is reduced.

In this way, it may be possible to adapt the depth of the memory buffer and for example, to decrease the depth of the memory buffer when the speed of display decreases or to increase the depth of the memory buffer when the speed of display increases.

This may permit a decrease in the latency within the decoder and thus may permit an improvement in the reaction time of the decoder. This may prove to be particularly beneficial during a change of display mode.

According to a preferred embodiment, when the decoder changes display mode, the first memory buffer is emptied.

This may also permit a decrease in the latency within the decoder when a change of display mode is performed.

The invention also relates to a device for processing digital images, comprising means of transmitting these images from a server to a decoder using various modes of display, the images being coded in a dependent manner such that the coding of a first image is used to code a second image.

According to the invention, the said device comprises means of determining the order of transmission of the images from the server to the decoder as a function of the dependence of these images and the mode of display requested by the decoder.

Finally, it should be pointed out that a method in accordance with the invention may readily be implemented in a known decoder as described later.

The invention also relates to a computer program product comprising program code instructions for the execution of the steps of the method of processing digital images according to one of the embodiments of the invention, when the said program is executed on a computer.

Other characteristics and advantages of the invention will become apparent in the description given hereinbelow, by way of non-limiting example, with reference to the following figures:

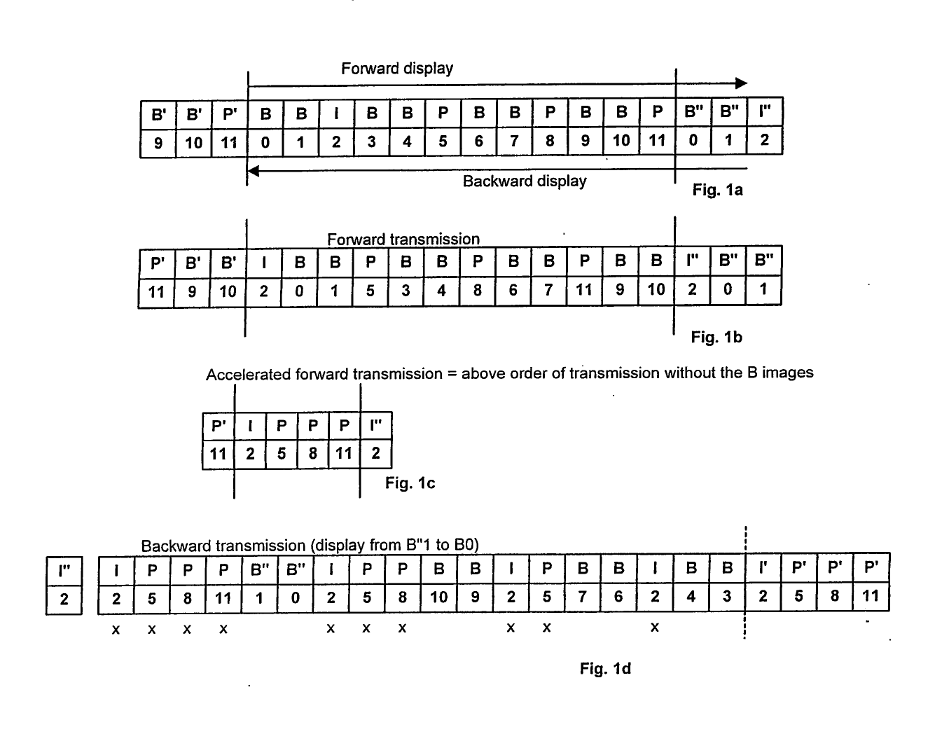

FIG. 1a represents the order of display of the data in forward mode and in backward mode,

FIG. 1b, 1c and 1d represent an example of the order of transmission of the images according to various modes of display,

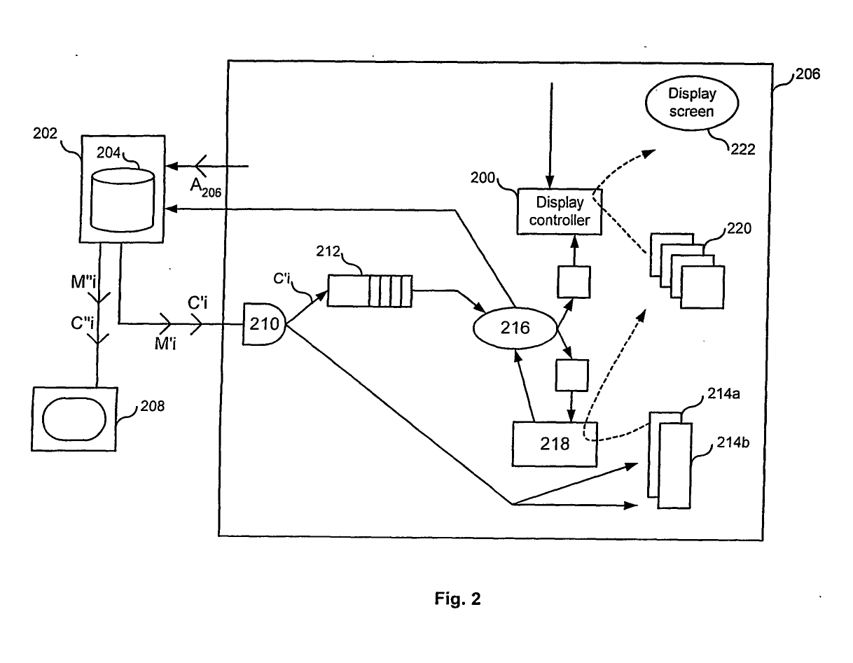

FIG. 2 represents a server and two terminals in accordance with an embodiment of the invention.

FIG. 1a represents a sequence of images coded according to the MPEG-2 standard.

The images are grouped into a sequence (GOP, Group of Pictures), comprising images coded according to the three modes described previously, I, B or P.

A sequence comprises 12 images in the embodiment represented. In FIGS. 1a, 1b, 1c and 1d, the images denoted I, B and P belong to a GOP, the images denoted I′, B′ and P′ belong to another GOP and the images denoted I″, B″ and P″ belong to yet another GOP.

When the mode of display is forward, the images are displayed in an order corresponding to the order of coding of the images, the image B0 being displayed first followed by the images B1, I2, B3 . . . P11 . . .

When the mode of display is backward, one commences by first displaying the image P11, B10, B99, . . . , B0 . . . . In this latter case, the images are therefore not displayed in the order in which they were coded, this entailing considerable decoding constraints and considerable resources in a decoding device intended for decoding these images so as to transmit them to a display device.

Represented in FIG. 1b is a sequence of images transmitted from the server to the decoder according to an embodiment of the invention when the mode of display is forward.

In order to limit the necessary resources in the decoder, the images are transmitted in an order making it possible to decrease the processing in the decoder.

Thus, the images are transmitted in the following order: I2, B0, B1, P5, B3, B4, P8, B6, B7, P11, B9, B10 . . . .

Represented in FIG. 1c is a sequence of images transmitted from the server to the decoder according to an embodiment of the invention when the mode of display is forward accelerated.

The type B images are not transmitted to the decoder. The I and P images are transmitted from the server to the decoder in the following order: I2, P5, P8, P11. . . .

Represented in FIG. 1d is a sequence of images transmitted from the server to the decoder according to an embodiment of the invention when the mode of display is backward.

The images of one and the same GOP are transmitted in the direction: I2, P5, P8, B10, B9, I2, P5, B7, B6, I2, B4, B3.

It is therefore found that certain images (those for which a cross is indicated under the sequence) are transmitted several times so as to facilitate the processing in the decoder.

Represented in FIG. 2 are a server 202 and terminals 206 and 208 intended for displaying images recorded in a recording medium (hard disk, CD, DVD) 204 of the server 202.

In accordance with the invention, the server 202 transmits images Mⱼ′ coded in a dependent manner, that is to say that a first image Mⱼ′ is coded by means of a second coded image Mₖ′, to the terminals 206 and 208.

Additionally, these images Mᵢ′ are transmitted with a command Cᵢ′ identifying a mode of display associated with the images Mᵢ′, a mode of display being defined inter alia by a direction and a speed of display.

To perform such a transmission of coded images Mᵢ′ and of command Cᵢ′, information A₂₀₆ relating to the mode of display selected by the user of the terminal is transmitted to the server 204 by the terminal 206.

As a function of the mode of display used by the terminal 206, various sequences of images as represented in FIGS. 1b, 1c and 1d, are transmitted to the terminal 206 to optimize the processing of these images.

The commands C′i et C″i transmitted by the server 202 to the devices 206 and 208 comprise information relating to the decodings and to the displays to be performed by the devices 206 and 208 in such a way as to allow the latter to perform monitoring of the processing to be performed on the images Mᵢ′, M″ᵢ and on the commands Cᵢ′, Cᵢ″ transmitted.

The table 1 below illustrates the various information (the list is not exhaustive) of the commands C′i et C″i.

| Name | Description |
|---|---|
| RDCId | Command identifier |
| Display | Indicates whether the image is to be displayed |
| BuffNr | Indicates the memory buffer in which the |
| | image is to be recorded after decoding. |
| Decode | Indicates whether the image is to be decoded |
| P_BuffNr | Indicates the index number of the memory |
| | buffer containing a P image which may be |
| | necessary to decode the current image. |
| I_BuffNr | Indicates the index number of the memory |
| | buffer containing an I image which may be |
| | necessary to decode the current image. |
| Forward | Indicates the direction of display. This |
| | item of information is used by the decoder |
| | to display two images in the interleaved mode. |

Optional

| | |
|---|---|
| Size | Size of the image (number of TS packets) |
| Type | Type of the image |
| TempRef | Time reference of the image. |
| commandeId | Indicates a command index number making |
| | it possible to ascertain the mode of display |
| | to which the transmitted image corresponds. |

On the basis of this information, the server 202 models the operation of the terminal 206, in particular in terms of available memory capacity, in such a way as not to transmit a quantity of data greater than the processing capacities, and than the storage resources of the terminal 206.

When the signal comprising the data Mᵢ′ and the command Cᵢ′ are received by the terminal 206, the signal is processed by a demultiplexer 210 transmitting the command Cᵢ′ to a register 212 and the coded images Mᵢ′ to a storage memory 214. The register 212 is preferably embodied as a memory of FIFO type (the acronym standing for first-in first-out).

In this embodiment, this memory comprises two submemories 214a and 214b used to store, respectively, the audio information and the video information received.

The storage register 212 transmits the commands Cᵢ′ to a controller 216 in an order corresponding to the order of storage in this register 212.

When a command Cᵢ′ is received by the controller 216, the latter commands by means of an element 218 the transmission of coded images from the storage memory 214 to a memory buffer 220 used for the decoding of the images. The module 218 is notified of the arrival of a new image in the memory buffer 214b and is commanded by the controller 216 to start the decoding of an image in the reconstruction memory buffers 220.

The decoded images are transmitted to the display screen 222 by way of a display controller 200.

In this preferred embodiment, four memory buffers 220 are used to boost the rate of processing of the images, in particular when a modification of the mode of display occurs.

When the mode of display is modified, information A₂₀₆ is transmitted to the server 202 which, modifying the coding of the images as a function of the new display mode, transmits new coded images Mᵢ″ associated with this new mode of display by means of a command Cᵢ″.

In a preferred embodiment, the register 212 has an adaptive depth that makes it possible to reduce the latency when the user changes the mode of display. Thus the commands recorded in the register 212 are eliminated and it is possible to go swiftly to the next mode of display.

In a variant, the register 212 is emptied when there is a change of display mode, this also making it possible to reduce the latency during a change of display mode.

The field Commandld makes it possible to ascertain the mode of display to which each image corresponds. This identifier is transmitted initially from the decoder 206 to the server 202 with the mode of display. Then, each image corresponding to this mode of display is transmitted according to the sequences illustrated in FIG. 1b, 1c or 1d with the identifier Commandld. Thus, during a change of display mode, the decoder, when it receives images corresponding to the previous mode of display, can empty the register 212.

In a variant, the memory buffers 220 are specific to a category of coded image, intra, bi-predictive or predictive.

When the images are coded according to the MPEG-2 standard, the CC field. (the acronym standing for <<continuity counter>>) contained in the transport type packets is no longer valid since the images are transmitted in a different order from the coding. To avoid discontinuities in the stream, it is conceivable to insert padding packets so as to reach the expected value of the CC field. According to another variant, it is also possible to ignore the CC field in the decoder.

When the images are coded according to the MPEG-2 standard, the commands C′i, C″i can be inserted into private sections by using a TS packet with a particular packet identifier (PID). In this case, the decoder decodes the PAT fields and the private tables.

The commands C′i and C″i can also be inserted into a packet of TS type specially created for this purpose which contains only an identifier and no data.

1. Method of processing digital images, these images being transmitted from a server to a decoder using various modes of display, images being coded once in a dependent manner such that the coding of a first image is used to code a second image, wherein, each image to be displayed together with the images of said once coded stream needed for its decoding constituting a group, each group is transmitted from the server to the decoder after the others in the order of display.

2. Method according to claim 1, wherein the mode of display used by the decoder is transmitted to the server so that the server performs the transmission of the images as a function of the mode of display used by the decoder.

3. Method according to claim 3, wherein, when the server transmits coded images to the decoder, the server in parallel therewith transmits a command associated with each image comprising information allowing the decoder to process each image.

4. Method according to claim 3, wherein the information comprises
a field indicating whether the said image is to be displayed,
a field indicating whether the said image is to be decoded,
a field indicating in which memory buffer of the decoder the said image is to be recorded after decoding,
a field indicating the index numbers of the memory buffers containing images serving for the decoding of the said image,
a field indicating the direction of display of the images.

5. Method according to claim 4, wherein, when the terminal receives coded images and a command associated with each image, the command is transmitted to a first memory buffer while the coded images are transmitted to other memory buffers.

6. Method according to claim 3, wherein the commands stored in the first memory buffer are processed as a function of their order of storage in the said memory buffer.

7-11. (canceled)

12. Method according claim 4, wherein the commands stored in the first memory buffer are processed as a function of their order of storage in the said memory buffer.

13. Method according claim 5, wherein the commands stored in the first memory buffer are processed as a function of their order of storage in the said memory buffer.

14. Method according to claim 1, wherein use is made of modes of display defined by a direction of display, that is to say the order in which images are displayed, as well as by a speed of display such that a variable number of images is displayed for one and the same processed group of images.

15. Method according to claim 2, wherein use is made of modes of display defined by a direction of display, that is to say the order in which images are displayed, as well as by a speed of display such that a variable number of images is displayed for one and the same processed group of images.

16. Method according to claim 3, wherein use is made of modes of display defined by a direction of display, that is to say the order in which images are displayed, as well as by a speed of display such that a variable number of images is displayed for one and the same processed group of images.

17. Method according to claim 4, wherein use is made of modes of display defined by a direction of display, that is to say the order in which images are displayed, as well as by a speed of display such that a variable number of images is displayed for one and the same processed group of images.

18. Method according to claim 5, wherein use is made of modes of display defined by a direction of display, that is to say the order in which images are displayed, as well as by a speed of display such that a variable number of images is displayed for one and the same processed group of images.

19. Method according to claim 6, wherein use is made of modes of display defined by a direction of display, that is to say the order in which images are displayed, as well as by a speed of display such that a variable number of images is displayed for one and the same processed group of images.

20. Method according to claim 12, wherein use is made of modes of display defined by a direction of display, that is to say the order in which images are displayed, as well as by a speed of display such that a variable number of images is displayed for one and the same processed group of images.

21. Method according to claim 13, wherein use is made of modes of display defined by a direction of display, that is to say the order in which images are displayed, as well as by a speed of display such that a variable number of images is displayed for one and the same processed group of images.

22. Method according to claim 5, wherein when the decoder changes display mode, the size of the first memory buffer is reduced.

23. Method according to claim 5, wherein when the decoder changes display mode, the first memory buffer is emptied.

24. Device for processing digital images, comprising means of transmitting these images from a server to a decoder using various modes of display, the images being coded once in a dependent manner such that the coding of a first image is used to code a second image, each image to be displayed together with the images of said once coded stream needed for its decoding constituting a group wherein it comprises means to transmit each group from the server to the decoder after the others in the order of display, the said device being preferably adapted to implement a method according to claim 1.

25. Computer program product comprising program code instructions for the execution of the steps of the method of processing digital images according to claim 1, when the said program is executed on a computer.
